(19) United States
(12) Patent Application Publication
(10) Pub. No.: US 2026/0357031 A1
(43) Pub. Date: Nov. 12, 2026

(54) RECOVERY OF CARBON FIBERS USING SOLVOLYSIS

(71) Applicant: Nandina Remanufacturing Pte Ltd, Singapore (SG)

(72) Inventors: Lake Looi LOH, Singapore (SG); Fraser KILLEN, Kureelpa (AU); Mohd FIRDAUS, Singapore (SG); Dazril PHUA, Singapore (SG)

(21) Appl. No.: 19/204,260

(22) Filed: May 9, 2025

(51) Int. Cl. C08J 11/26; B29B 17/02; C08K 3/04; C08K 7/04; B29K 101/00; B29K 105/12; B29K 105/26; B29K 307/04

(52) U.S. Cl. CPC C08J 11/26; B29B 17/021; C08K 3/04; C08K 7/04; B29B 2017/0289; B29B 2017/0293; B29K 2101/00; B29K 2105/12; B29K 2105/26; B29K 2307/04; C08J 2300/12

(57) ABSTRACT

Systems and methods for recycling carbon fiber reinforced plastics (CFRP) are described. CFRP feedstock is introduced together with a solvolysis solution at atmospheric pressure into a reactor vessel for solvolysis. The solvolysis process recovers carbon fibers utilizing cost effective modular reactor vessels which can accommodate production volumes from lab scale to industrial scale. Subsequent rinsing and drying of recovered fibers to prepare for downstream remanufacturing is also described.

### BACKGROUND

### 1. Field

The present disclosure relates generally to recovery of carbon fibers using solvolysis.

### 2. Description of the Related Art

Solvolysis is a chemical process used for decomposing polymeric materials by reacting them with a solvent, typically under controlled temperature and pressure conditions. In the context of recycling composite materials, solvolysis enables the breakdown of resin matrices in fiber-reinforced composites such as carbon fiber reinforced plastics (CFRP), facilitating the recovery of valuable reinforcement carbon fibers. Traditional solvolysis methods often rely on elevated temperatures, high pressures, or specialized chemical formulations to achieve efficient resin degradation. These processes have been explored as alternatives to thermal recycling techniques such as pyrolysis, offering potential benefits such as preservation of fiber length and tensile strength. However, solvolysis systems can be limited by cost, energy demands, and scalability, particularly at industrial levels. Moreover, variations in feedstock composition and resin type present ongoing challenges for consistent and efficient fiber recovery across a broad range of composite materials.

### SUMMARY

The following is a non-exhaustive listing of some aspects of the present techniques. These and other aspects are described in the following disclosure.

Recycling carbon fiber reinforced plastics (CFRP) is described. CFRP feedstock is introduced together with a solvolysis solution at atmospheric pressure into a reactor vessel for solvolysis. The solvolysis process recovers carbon fibers utilizing cost effective modular reactor vessels which can accommodate production volumes from lab scale to industrial scale. Subsequent rinsing and drying of recovered fibers to prepare for downstream remanufacturing is also described.

Some aspects include a method for recycling carbon fiber reinforced plastics (CFRP). The method comprises introducing CFRP feedstock together with a solvolysis solution into a reactor vessel for solvolysis. The reactor vessel is configured to maintain the CFRP feedstock and the solvolysis solution at atmospheric pressure. The method comprises heating the reactor vessel to increase a temperature of the solvolysis solution and the CFRP feedstock to maintain a target temperature for a period of time. The method comprises mechanically agitating the CFRP feedstock and the solvolysis solution in the reactor vessel with a stirrer during the heating to facilitate CFRP feedstock degradation and carbon fiber dispersion. The stirrer is configured to cause the carbon fibers to gradually disperse and reduce or eliminate entanglement of carbon fibers on the stirrer. The method comprises separating recovered carbon fibers from the solvolysis solution; rinsing the recovered carbon fibers with a washing process to remove residual resin and chemical residues; and drying the rinsed carbon fibers.

In some embodiments, the solvolysis solution comprises a target mixture of radicals configured to break chemical bonds in the CFRP feedstock.

In some embodiments, the heating is performed by a heater comprising a heating jacket configured to wrap around at least a portion of the reactor vessel.

In some embodiments, the reactor vessel is modular, with reactor vessel modularity configured to facilitate reactor vessel replacement, and/or scaling by adding or subtracting a number of reactor vessels used for the method while solvolysis is ongoing in other reactor vessels.

In some embodiments, the reactor vessel comprises high-density polyethylene (HDPE), stainless steel, and/or other materials.

In some embodiments, an electronic parameter model is configured to determine one or more of temperature, time, and/or agitation parameters of the solvolysis based on a CFRP feedstock identifier, physical characteristics of the CFRP feedstock, and/or other factors.

In some embodiments, the washing process comprises immersion of the recovered carbon fibers in a continuously agitated aqueous solution.

In some embodiments, the method comprises distilling and reusing the solvolysis solution after separation of the carbon fibers.

In some embodiments, the method comprises pressing the recovered carbon fibers using a hydraulic press before rinsing.

In some embodiments, drying the rinsed carbon fibers is performed using a wool drying technique. In some embodiments, drying the rinsed carbon fibers comprises passing heated air over the rinsed carbon fibers at a controlled flow rate.

In some embodiments, the method comprises forming chopped carbon fibers, pellets, fabrics, a unidirectional carbon fiber roll, and/or pre-impregnated carbon fiber components from the dried rinsed carbon fibers.

In some embodiments, the CFRP feedstock is obtained from retired aircraft.

In some embodiments, the stirrer is a hook-type stirrer.

Some aspects include a system, including: a reactor vessel, a heater, a stirrer, and/or other components configured to effectuate operations of the above-mentioned method.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a flowchart of a method for recycling carbon fiber reinforced plastics (CFRP).

FIG. 2 provides another illustration of the method for recycling CFRP, including additional and/or alternative potential operations.

FIG. 3 illustrates a system for recycling CFRP.

FIG. 4 illustrates an example of a reactor vessel, with a heater.

FIG. 5 illustrates an additional potential embodiment of the reactor vessel.

FIG. 6 illustrates example embodiments of post-solvolysis processing equipment for handling recovered carbon fibers

FIG. 7 illustrates various products, such as a non-woven fabric, carbon fiber pellets, chopped carbon fiber, and unidirectional carbon fiber (there are other examples), that can be produced with the recycled carbon fibers after solvolysis, washing, and/or drying as described herein.

FIG. 8 is a diagram that illustrates an exemplary computing system in accordance with embodiments of the present system.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of recycling carbon fiber reinforced plastics (CFRP), and other fields. The inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

The present disclosure relates to systems and methods for the recovery of carbon fibers from composite materials, such as CFRP, using a scalable and energy-efficient solvolysis process. The disclosed approach integrates novel reactor configurations and process workflows that operate under mild conditions - e.g., relatively low temperature (compared to conventional techniques) and ambient pressure - thereby minimizing equipment cost and complexity. The disclosed approach is designed to accommodate a wide variety of carbon fiber feedstocks, including woven, non-woven, and unidirectional composites, and can be implemented using components such as containers made from high-density polyethylene (HDPE) or stainless steel, industrial mixers, and heating jackets, for example.

Conventional solvolysis techniques typically require specialized pressure vessels, custom fabrication, or high-temperature operation, which limit scalability and drive up capital expenditure. In contrast, the present systems and methods employ a modular reactor design that enables parallel batch processing without the need for high-pressure containment or custom-engineered reactors. An integrated agitation mechanism - such as a hook-style mixer - facilitates the simultaneous dispersion and chemical degradation of composite materials, improving reaction efficiency, especially for multilayer woven substrates. This dual-functionality reduces processing time and eliminates the need for manual fiber separation post-solvolysis, among other advantages.

The disclosed systems and methods also incorporate an industrial-scale rinsing and drying workflow. This eliminates the need for labor-intensive manual cleaning or energy-intensive oven drying, further enhancing the economic viability of these techniques. Together, these innovations enable cost-effective carbon fiber recovery at various production volumes, from laboratory to industrial scale, while preserving fiber quality and mechanical integrity. The resulting recovered fibers may be reused in a variety of downstream applications, including in structural components, thermoplastic composites, and non-woven fabrics, supporting a more recycling based and sustainable composites industry, among others.

Note that even though carbon fibers are discussed extensively, the solvolysis techniques described herein could also be potentially applied to other epoxy-based composite materials containing other types of fibers such as glass, for example.

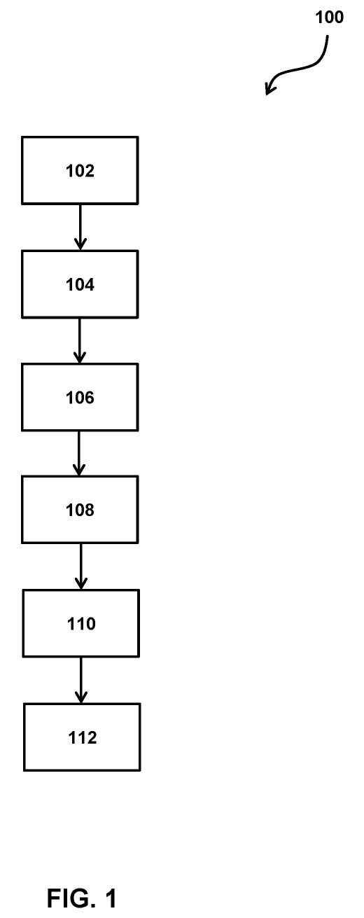

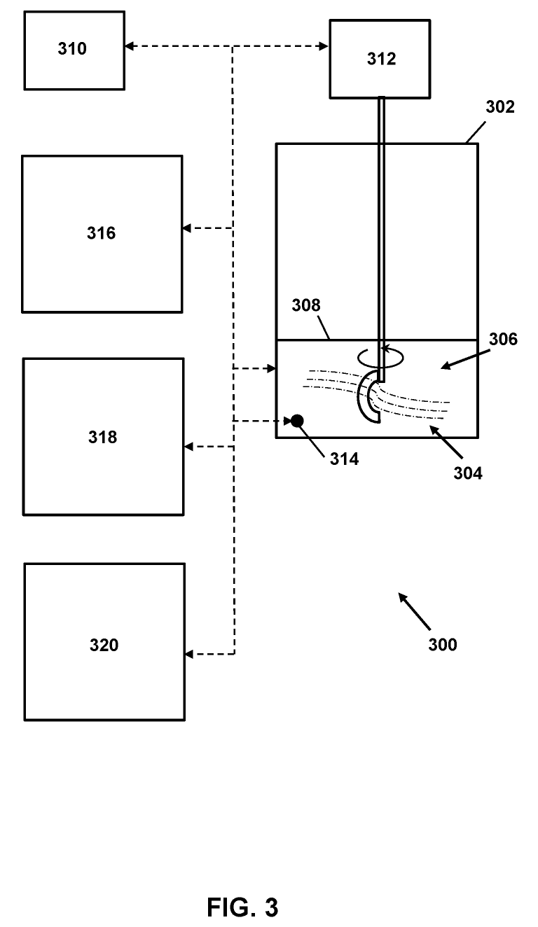

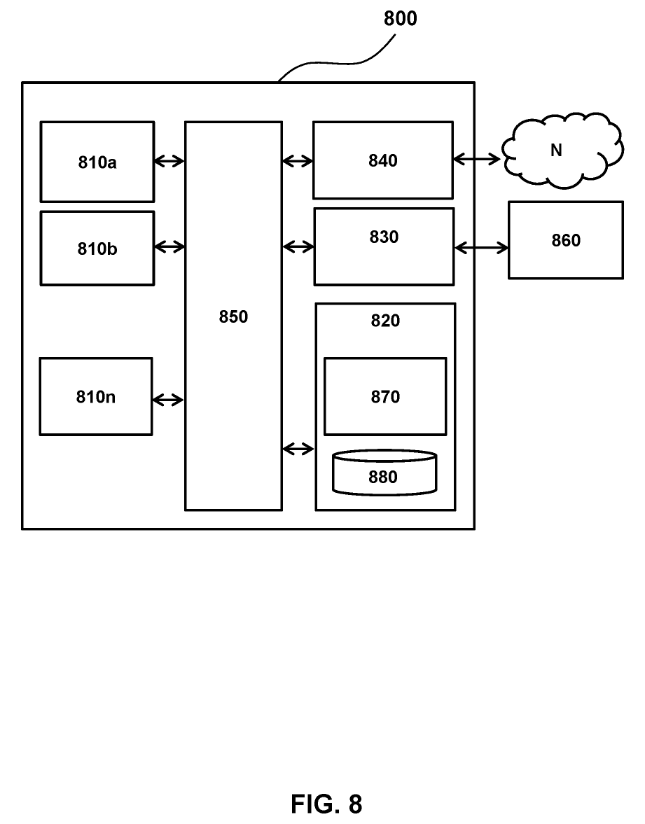

FIG. 1 is a flowchart of a method 100 for recycling CFRP. Some or all of the operations of method 100 may be performed with a system such as system 300 (FIG. 3), computer system 800 (FIG. 8), and/or other components discussed herein. Method 100 may include additional operations that are not described, and/or may not include one or more of the operations described below. The operations of method 100 may be performed in any order that facilitates recycling CFRP.

Method 100 begins with operation 102, comprising introducing CFRP feedstock together with a solvolysis solution into a reactor vessel for solvolysis. The term CFRP feedstock refers to carbon fiber reinforced polymer composite material, which typically includes carbon fibers embedded in a cured polymeric resin matrix, such as an epoxy resin. The CFRP feedstock may be introduced in various forms, including chopped segments, flat laminate sheets, or segmented panels derived from larger composite structures. The solvolysis solution and the CFRP feedstock may be introduced sequentially or simultaneously, depending on reactor configuration and process controls. Introduction may be accomplished manually or via automated loading systems, including hoppers, gravity-fed chutes, or pump-assisted solvent injection systems, for example.

The CFRP feedstock may be obtained from retired aircraft, for example, or other sources. These other sources may include decommissioned wind turbine blades, end-of-life automotive or marine composite components, industrial scrap material, expired prepreg rolls, or offcuts from composite manufacturing lines. For aerospace applications, CFRP may be recovered from aircraft interior panels, floorboards, wing spars, or structural fairings, for example. Such materials often contain high-grade carbon fibers and thermoset epoxy matrices, making them suitable for solvolysis-based recycling. Prior to introduction into the reactor, the CFRP may be mechanically processed - e.g., cut, ground, or abraded - to facilitate solvent penetration and uniform chemical degradation during solvolysis.

The solvolysis solution comprises a target mixture of radicals configured to break chemical bonds in the CFRP feedstock. Radicals comprise reactive chemical species, typically derived from a formulated solvent system, capable of cleaving the covalent bonds within the polymeric matrix—particularly the ether, ester, or amine linkages found in epoxy resins. The solution may include oxidizing or nucleophilic components, such as peroxides, amines, or alcohols, and may be selected to function under mild conditions (e.g., below 100 °C, at atmospheric pressure). The solution may also include stabilizers, surfactants, or catalysts to enhance selectivity and efficiency. In some embodiments, the radical species are generated in situ, for example, via chemical or thermal activation of precursor compounds, enabling the breakdown of the matrix and the release of intact carbon fibers. In some embodiments, the solution comprises an organic solvent including acetic acid, a peroxide. In some embodiments, the solution comprises a mixture of organic solvents and a catalyst, formic acid, hydrogen peroxide, benzoyl peroxide, acetyl peroxide, dilauryl peroxide, citric acid, tartaric acid, phosphoric acid, acetic acid, benzyl alcohol, phenol cresol, catechol, resorcinol, hydroquinone, hydroxyl benzoic acid, nitrophenols, nitrosophenols, phonolic aldehydes, methane sulfonic acid, toluene sulfonic acid, an ion alkali solution, an aprotic polar solvent, a proton acid, a polyol solvent, an ionic liquid, phosphonium ion, ammonium ion, hexafluorophosphate ion, imidazolium ion, pyrrolidinium, pyridinium, imide, sulfonate, trifluoromethane sulfonyl imide, triphenylphosphine oxide, and/or other materials.

The mild conditions, or mild solvolysis, as used herein, refers to depolymerization processes for composite materials that are carried out under relatively low temperature and pressure conditions, typically at or near atmospheric pressure and at temperatures below approximately 100 °C (e.g., mild solvolysis describes a solvolysis process at low temperatures, in the liquid phase of a chemical solvent) and ambient pressure. In contrast to conventional solvolysis techniques that may require elevated pressures and temperatures—such as autoclave systems operating at 150–250 °C and several bar of pressure—mild solvolysis minimizes thermal and mechanical stress on recovered fibers and allows for the use of simpler, lower-cost reactor systems and materials, among other advantages. The term mild also denotes the avoidance of highly corrosive solvents or highly exothermic conditions, thereby enhancing operational safety, reducing energy consumption, and preserving the mechanical integrity, length, and surface quality of the recovered carbon fibers, for example.

The reactor vessel is configured to maintain the CFRP feedstock and the solvolysis solution at atmospheric pressure. Maintaining atmospheric pressure offers significant advantages over traditional high-pressure systems, including reduced safety risk, simpler containment design, and compatibility with less expensive materials such as plastics. The reactor vessel is modular. Reactor vessel modularity is configured to facilitate reactor vessel replacement, and/or scaling by adding or subtracting a number of reactor vessels used for the method while solvolysis is ongoing in other reactor vessels. Modularity permits parallel batch processing and redundancy; for example, if one vessel requires cleaning or replacement, solvolysis can continue uninterrupted in the remaining vessels.

Modular means that the reactor vessel is configured to facilitate interchangeability, scalability, and ease of assembly or replacement without requiring fundamental redesign or interruption of the solvolysis process. A modular reactor vessel system is composed of individual, functionally complete reactor units that can be operated independently or in parallel, and that may be added to or removed from the overall system dynamically, for example, to meet varying throughput demands or to perform maintenance on a single unit while others remain operational. Modularity may be expressed in physical terms. For example, each vessel may be self-contained and may be fabricated in a standard size (e.g., 5L, 10L, 50L, or 250L capacity) with standardized interfaces such as fluid inlets, outlets, heating jackets, stirrers, etc.. Modularity may be expressed in operational terms. For example, each reactor can be controlled independently with respect to temperature, mixing speed, and reaction duration, allowing for processing of different feedstocks or solvents simultaneously. Modularity may be expressed in terms of scalability. For example, a system of reactor vessels can be scaled up by simply increasing the number of reactor vessels rather than increasing the size or complexity of a single large vessel. This approach supports linear scale-up without substantial redesign. Modularity may be expressed in terms of serviceability. For example, if one reactor vessel becomes fouled or reaches the end of its service life (e.g., due to corrosion or wear), it may be removed and replaced without halting the entire operation.

For example, a solvolysis facility may operate with ten modular high-density polyethylene (HDPE) reactor vessels running simultaneously, and additional units can be installed as demand increases. In some embodiments, modular reactor vessels may be mounted on wheeled bases or in removable frames to enable batch rotation or off-site cleaning. The modular architecture also facilitates low capital expenditure, fast deployment, and distributed processing, for example. This architecture also supports scalable deployment across small laboratory settings and large industrial installations, where reactor arrays can be expanded incrementally to meet increasing throughput demands.

In some embodiments, the reactor vessel comprises HDPE, stainless steel, and/or other materials. HDPE is advantageous due to its chemical resistance and low cost, and may be used for lower-temperature operations. Stainless steel, including grades such as 304 or 316, may be used for higher temperature or more chemically aggressive formulations. Other materials may include glass-lined steel, polypropylene, or polytetrafluoroethylene (PTFE)-lined vessels depending on solvent compatibility and thermal requirements. The selection of material for a reactor vessel may also be based at least in part on ease of cleaning, mechanical durability, compliance with regulatory requirements for chemical processing, and/or other factors. In some embodiments, the reactor vessel may include internal baffles or mixing aids, and may be outfitted with seals, ports, or access hatches to enable sampling, agitation, or solvent replenishment, and/or other operations.

Method 100 continues with operation 104, comprising heating the reactor vessel to increase a temperature of the solvolysis solution and the CFRP feedstock to maintain a target temperature for a period of time. The target temperature may be determined based on the kinetics of the solvolysis reaction and the thermal stability of the reactor material, among other factors. For example, in mild solvolysis processes, the target temperature may range from approximately 40 °C to 100 °C, allowing for effective resin degradation while preserving carbon fiber integrity. The duration of heating may vary from up to 5, 10, 15, or 30 minutes, to several hours, depending on the CFRP feedstock, solvent formulation, batch size, and/or other factors. Temperature may be monitored via one or more sensors such as integrated thermocouples or wireless temperature sensors placed within the solvolysis solution and/or in the reactor wall, and may be controlled using programmable logic controllers (PLCs), manual thermostatic systems, and/or other controllers (e.g., see controller 310 in FIG. 3), for example.

In some embodiments, the heating is performed by a heater comprising a heating jacket configured to wrap around at least a portion of the reactor vessel. In some embodiments, the heater may be an induction heater integrated into the mixing element, a submersible heating coil placed within the solvolysis solution, a heat-conductive stirrer shaft that transfers thermal energy while simultaneously agitating the feedstock, and/or other heaters. For example, the heater may be, include, and/or utilize a heating mat, external resistance heaters, or thermally controlled hot plates placed beneath the reactor vessel, depending on the material of the vessel and the desired thermal profile.

Operation 106 comprises mechanically agitating the CFRP feedstock and the solvolysis solution in the reactor vessel with a stirrer during the heating to facilitate CFRP feedstock degradation and carbon fiber dispersion. In some embodiments, operation 106 is optional. Mechanical agitation promotes uniform heat and mass transfer throughout the reaction medium and accelerates solvent penetration into the composite matrix, particularly in multi-layered or tightly woven CFRP structures. Mechanical agitation during solvolysis also prevents localized concentration gradients of reactive species, ensuring more consistent degradation of the polymer matrix and enhancing the release of intact carbon fibers from the resin. The stirrer is configured to cause the carbon fibers to gradually disperse and reduce or eliminate entanglement of carbon fibers on the stirrer. Fiber entanglement is a common challenge in solvolysis of composite laminates, where released fibers tend to clump or wrap around traditional stirrer geometries, such as blades or paddles, leading to reduced mixing efficiency and increased mechanical stress on the fibers.

In some embodiments, the stirrer is a hook-type stirrer. A hook-type stirrer refers to a curved or looped mixing element designed to rotate within the vessel in a manner that gently lifts and repositions fibers without cutting, shearing, or winding them around the shaft. This geometry is effective at dispersing long, flexible carbon fibers released during solvolysis of woven or continuous fiber composites, minimizing mechanical damage and preserving fiber length. In some embodiments, the hook-type stirrer may rotate eccentrically or along a variable-speed shaft to create additional turbulence and mixing zones within the reactor vessel. In some embodiments, the stirrer may be made of chemically resistant materials such as stainless steel, PTFE-coated metals, or HDPE, and may be integrated with additional features such as temperature sensors, baffles, or scraping blades to prevent sediment buildup or fiber clumping.

In some embodiments, the mechanical agitation may be supplemented by movement of the reactor vessel itself, such as via orbital shaking, tilting, or vibration, or by incorporating split-column flow guides within the vessel to generate secondary flow patterns. The combination of thermal energy and mechanical dispersion enables simultaneous solvolysis and fiber separation within a single process step, improving cycle time and throughput efficiency. This integrated approach reduces or eliminates the need for post-processing steps such as manual fiber teasing or secondary dispersion tanks, thereby lowering labor intensity and operational complexity, for example.

In some embodiments, an electronic parameter model is configured to determine one or more of temperature, time, and/or agitation parameters of the solvolysis based on a CFRP feedstock identifier, physical characteristics of the CFRP feedstock, and/or other information. A controller (e.g., controller 310 shown in FIG. 3, which may be and/or include a computer system such as system 800 shown in FIG. 8) may execute the electronic parameter model, for example.

In some embodiments, the electronic parameter model may comprise one or more individual algorithms. In some embodiments, an algorithm may be a machine learning algorithm. In some embodiments, the machine learning algorithm may be or include a neural network, classification tree, decision tree, support vector machine, or other model that is trained. As an example, neural networks may be based on a large collection of neural units (or artificial neurons). Neural networks may loosely mimic the manner in which a biological brain works (e.g., via large clusters of biological neurons connected by axons). Each neural unit of a neural network may be simulated as being connected with many other neural units of the neural network. Such connections can be enforcing or inhibitory in their effect on the activation state of connected neural units. In some embodiments, each individual neural unit may have a summation function which combines the values of all its inputs together. In some embodiments, each connection (or the neural unit itself) may have a threshold function such that the signal must surpass the threshold before it is allowed to propagate to other neural units. These neural network systems may be self-learning and trained, rather than explicitly programmed, and can perform significantly better in certain areas of problem solving, as compared to traditional computer programs. In some embodiments, neural networks may include multiple layers (e.g., where a signal path traverses from front layers to back layers). In some embodiments, back propagation techniques may be utilized by the neural networks, where forward stimulation is used to reset weights on the “front” neural units. In some embodiments, stimulation and inhibition for neural networks may be more free flowing, with connections interacting in a more chaotic and complex fashion. In some embodiments, the electronic parameter model comprises a large language model.

Training of the electronic parameter model may be supervised or unsupervised. In some embodiments, training configures the electronic parameter model to learn a generic associativity of input prompts, and once trained, to be deployed to output responses to those prompts. In some embodiments, the electronic parameter model may be trained initially using input output training pairs (e.g., a process temperature, time, and/or agitation parameter of the solvolysis with a corresponding CFRP feedstock identifier, physical characteristics of the CFRP feedstock, and/or other information) that provide an expected output (e.g., successful solvolysis) based on a provided input, and/or other data.

Operation 108 comprises separating recovered carbon fibers from the solvolysis solution. Separation may be performed by filtration, mechanical straining, draining a liquid phase from a solid fiber mass, and/or other techniques. In some embodiments, the reactor vessel may include an integrated drainage port or filter basket that retains the recovered carbon fibers while allowing the solvolysis solution to be evacuated. For example, a sieve may be arranged proximate the bottom of the reactor vessel so that the degraded resin can drop down to the bottom of the reactor vessel. The reactor vessel may have a drainage port at the bottom, below the sieve, to facilitate the drainage of the degraded resin and liquid. A (hydraulic) press (e.g., as described elsewhere herein) may be inserted into the reactor vessel to press liquid from recovered fibers, facilitate rinsing, and again pressing the liquid from the fibers before washing (e.g., all as described herein). This further simplifies the process with less equipment, among other advantages. The recovered carbon fibers may retain absorbed solvent, resin residues, or fine particulates, and are typically in a semi-wet or gel-like state at this stage. Efficient separation enables downstream processing of both the fibers and the solution with minimal cross-contamination or material loss.

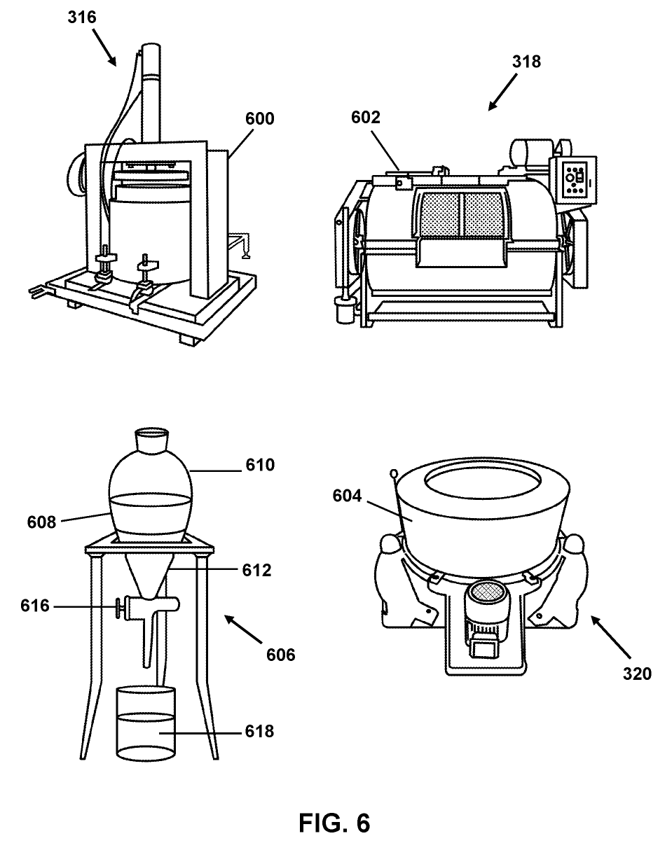

In some embodiments, the solvolysis solution is distilled and reused after separation of the carbon fibers. Distillation facilitates recovery and purification of volatile and semi-volatile components of the solvolysis solution mixture, reducing chemical waste, and improving overall process economics. For example, components such as ethanol, acetone, or proprietary low-boiling-point reactants may be recovered under reduced pressure using a rotary evaporator or distillation column. The non-volatile residues, such as degraded resin fragments or byproducts, may be filtered or centrifuged out before reuse. This recycling loop enhances the sustainability and cost-effectiveness of the solvolysis process. However, in some embodiments, distillation may not be performed, as the soluble resin once distilled can potentially foul up a distillation tray. Removal of the resin at the bottom of a column may be needed to open up a distillation column (see FIG. 6) in the event resin solidifies. In these embodiments, the solvent may be filtered, an epoxy resin drained, the soluble epoxy resin may be left in the system, the spent solvent may be doped (after the epoxy resin is drained) with a dehydrator to concentrate the acid/solvent, and/or other operations may occur. After doping, the mixture may be filtered to drain the solid. The soluble degraded resin which is in equilibrium may drop out once the concentration of the resin increases when reused.

Operation 110 comprises rinsing the recovered carbon fibers with a washing process to remove residual resin and chemical residues. Operation 110 is configured to ensure that the recovered fibers are free from contaminants that could interfere with downstream manufacturing processes or compromise the mechanical properties of remanufactured composite materials. For example, residual resin or solvent can lead to poor adhesion in new matrices or introduce variability in fiber surface energy, affecting composite performance. The washing process may utilize water or aqueous solutions containing surfactants, neutralizing agents, or mild detergents to aid in resin residue removal. Operation 110 may be conducted as a batch process or in a continuous flow-through system, for example.

In some embodiments, the washing process of operation 110 comprises immersion of the recovered carbon fibers in a continuously agitated aqueous solution. Continuous agitation may be achieved using mechanical stirrers, rotating drums, or ultrasonic agitation, and is configured to prevent fiber matting, while ensuring uniform exposure of fiber surfaces to the rinsing. Agitation helps lift embedded contaminants from within fiber bundles and promotes effective rinse action throughout the fiber volume. In some embodiments, industrial washing machines adapted from the textile or wool industry may be employed to deliver consistent, energy-efficient fiber cleaning at scale. Agitation intensity and cycle duration may be optimized based on the type of resin removed and the physical characteristics of the fiber, among other factors.

In some embodiments, operation 110 comprises pressing the recovered carbon fibers using a hydraulic press before rinsing. As described above, a (hydraulic) press may be inserted into the reactor vessel to press liquid from recovered fibers, facilitate rinsing, and again pressing the liquid from the fibers before washing (e.g., all as described herein). Operation 110 is configured to remove excess liquid from the fiber material prior to rinsing, increasing the efficiency of the subsequent rinse and reducing water demand. The hydraulic press may apply a controlled compressive force, which may depend on batch size, fiber density, and/or other factors, to express trapped solvent and enable more effective penetration of rinse media during washing. Operation 110 may also help compact the fibers into a more manageable shape for automated handling or conveyance to washing stations, for example.

Operation 112 comprises drying the rinsed carbon fibers. In some embodiments, drying the rinsed carbon fibers is performed using a wool drying technique. Wool drying techniques may include spin-drying combined with gentle thermal air flow to preserve fiber length and alignment. This method is advantageous because it minimizes thermal degradation and fiber entanglement compared to oven or infrared drying systems, among other advantages. In some embodiments, drying the rinsed carbon fibers comprises passing heated air over the rinsed carbon fibers at a controlled flow rate. For example, heated air at temperatures above about 40 °C may be circulated across fiber beds on mesh trays or in tumbling dryers. Airflow rate, humidity control, drying time, and/or other factors may be adjusted based on fiber volume and moisture content to ensure consistent drying without overheating.

In some embodiments, operation 112 comprises forming chopped carbon fibers, pellets, fabrics, a unidirectional carbon fiber roll, and/or pre-impregnated carbon fiber components from the dried rinsed carbon fibers. The dried carbon fibers may be cut to specified lengths for use in thermoplastic pellet production or chopped fiber mats. Alternatively, the fibers may be carded laid into non-woven or woven configurations to form fabrics or structural mats. For structural reinforcement applications, the fibers may be aligned and spooled into unidirectional rolls. In yet other embodiments, the carbon fibers may be impregnated with resin to form prepregs suitable for molding or layup in aerospace, automotive, or sporting goods industries. The flexibility of output forms enhances the commercial applicability of the recovered fibers, for example.

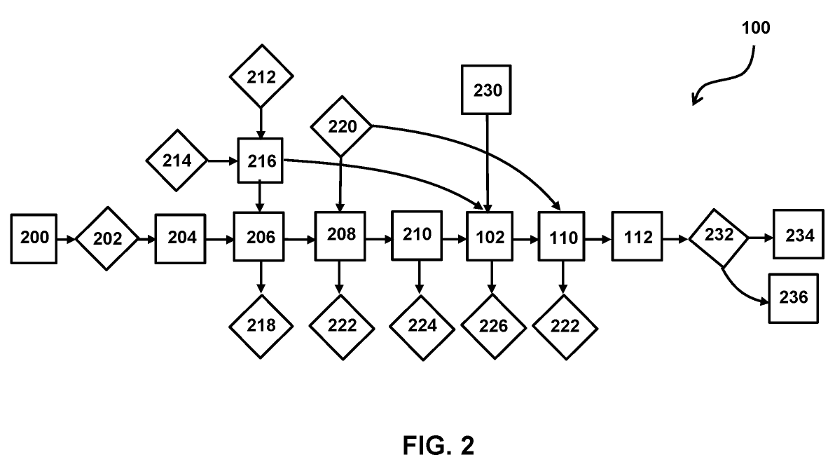

FIG. 2 provides an expanded illustration of the method for recycling carbon fiber reinforced plastics (CFRP), referred to generally as method 100, and includes additional and/or alternative operations that may be used in conjunction with or in place of the operations shown in FIG. 1. FIG. 2 emphasizes the front-end material preparation and post-processing operations that support and enhance the overall recovery and remanufacturing workflow. In some embodiments, as with FIG. 1, any one or more of the illustrated operations may be performed, in the illustrated sequence or another order, depending on the source, form, or condition of the incoming CFRP and the requirements of downstream processing, and/or other factors.

Received 200 incoming CFRP may not yet be the CFRP feedstock described above related to FIG. 1, and instead may comprise larger pieces, pieces with other material attached (e.g., larger chunks of a disassembled aircraft), and/or other incoming CFRP. Incoming CFRP is received 200, which may comprise composite parts or structures from retired aircraft, such as floorboards, wing panels, fairings, interior panels, or other CFRP-containing components. These incoming parts are often not yet suitable for solvolysis and may include embedded fasteners, adhesives, or structural inserts such as aluminum cores. At verification step 202, the material may be visually or digitally inspected, weighed, scanned, or otherwise characterized to assess source identity, condition, resin type, fiber form (e.g., woven, unidirectional, non-woven), and potential contaminants. In some embodiments, image recognition software or material database identifiers may be used to classify incoming CFRP parts and determine appropriate processing pathways.

The incoming CFRP may be sorted 204 into batches, pre-treated 206, and initially rinsed 208 (e.g., in addition to operation 110), before being processed 210 into CFRP feedstock. For example, following verification, the incoming CFRP is sorted 204 into appropriate batches based on characteristics such as fiber type, resin system, structural geometry, or degradation level. Sorting may be manual or semi-automated. Sorting may facilitate consistent solvolysis behavior and uniformity in the recovered carbon fiber properties, for example, and/or have other benefits. Sorted batches may then undergo pre-treatment 206, which prepares the material for conversion into CFRP feedstock. Pre-treatment may include mechanical operations such as panel sawing, band sawing, and sanding to segment laminated panels, remove outer layers (e.g., honeycomb, fiberglass), or expose face sheets. Additionally, chemical agents 212, compressed air 214, and diaphragms or pumps 216 may be used to dislodge contaminants or pre-soften surface resin layers, e.g., in cases where adhesive layers or thermal coatings are present.

Initial rinsing 208 may also be applied during or after pre-treatment 206 to reduce surface contaminants and/or improve solvent accessibility during subsequent solvolysis, among other potential purposes. Water 220 may be introduced via spray nozzles, immersion tanks, washing drums, and/or other components. Output 222 - which may comprise loosened resin particles, dirt, or pre-treatment chemical residues, for example – may be collected for filtration, reuse, or discharge. Output streams from pre-treatment 206 may include spent solvent 218, solid waste 224 (e.g., fiberglass, adhesives, honeycomb cores, metal inserts), or other unusable materials, which may be separated prior to creation of the final CFRP feedstock during processing 210. For example, spent solvent 218 and/or other byproducts may be output from pre-treatment 206. Water 220 may be input for rinsing 208 (and rinsing operation 110), and output 222 with any additional spent solvent. The processing 210 operation produces feedstock in suitable form - e.g., target size pieces of woven or non-woven segments - for introduction into the solvolysis reactor vessel in operation 102, as described with reference to FIG. 1.

Heating operation 230 provides thermal regulation of the solvolysis process. As described herein, a heater (e.g., heater 308 - see FIG. 3 below) may comprise a heating jacket, immersion coil, an induction element, and/or other components. The heater is configured to raise the solution and CFRP feedstock to a target temperature, typically between 40 °C and 100 °C, under atmospheric pressure. Real-time thermal data may be obtained via a temperature sensor (e.g., temperature sensor 314 shown in FIG. 3) and used by a controller (e.g., controller 310 shown in FIG. 3) to maintain the desired temperature for the duration of the reaction cycle. Following solvolysis, recovered carbon fibers are separated, washed, dried, and may undergo a carbon fiber grading operation 232. Grading may include measurement of fiber length, tensile strength, residual resin content, surface quality, and/or other characteristics. These assessments may be manual, semi-automated, sensor-based, and/or facilitated by other mechanisms, and may be used to determine an appropriate downstream use case for each fiber batch, for example.

Once graded, recycled carbon fiber output 234 is collected and may be used to form chopped fibers, pellets, unidirectional rolls, prepregs, or non-woven fabrics, as described herein. In some embodiments, batches that do not meet quality thresholds, exhibit inconsistent resin removal, etc., may be directed to a re-work operation 236, where additional rinsing, dispersion, drying, and/or other operations may be applied to meet quality control standards. Re-worked material may then be reintegrated into the output stream.

FIG. 3 illustrates a reactor system 300 for recycling CFRP. System 300 comprises a reactor vessel 302, a heater 308, a controller 310, a stirrer 312, a temperature sensor 314, a press 316, a washer 318, a dryer 320, and/or other components. Reactor vessel 302 is configured to receive CFRP feedstock 304 and a solvolysis solution 306 for chemical degradation of the polymer matrix of CFRP feedstock 304. Reactor vessel 302 is configured to maintain both CFRP feedstock 304 and solvolysis solution 306 at atmospheric pressure, eliminating the need for pressure-rated components and allowing the use of cost-effective materials such as high-density polyethylene (HDPE) or stainless steel, for example, depending on chemical compatibility and thermal requirements. In some embodiments, as described above, reactor vessel 302 is modular, allowing system 300 to be scaled by adding or removing individual reactor vessels 302 without interrupting solvolysis operations in adjacent vessels 302. Modular design also enables quick vessel 302 replacement in case of fouling or maintenance needs, thereby increasing system 300 uptime and operational flexibility, among other advantages.

Heater 308 is configured to heat reactor vessel 302 to increase a temperature of the solvolysis solution 306 and the CFRP feedstock 304, and maintain a target temperature for a period of time. In some embodiments, heater 308 comprises a heating jacket configured to wrap around the exterior of at least a portion of reactor vessel 302. In some embodiments, heater 308 may comprise a heating mat, an induction heater integrated with stirrer 312, an immersible coil heater placed directly into the reaction mixture, and/or other heaters. System 300 may include a temperature sensor 314, positioned within or near the solvolysis solution 306. Sensor 314 is configured to generate output signals representing the real-time temperature of solvolysis solution 306. These signals are transmitted, either via wired connections (e.g., thermocouple cables) or wirelessly (e.g., Bluetooth), to controller 310.

Controller 310 may be implemented as and/or include one or more processors, a computer system (e.g., computer system 800 shown in FIG. 8), a programmable logic controller (PLC), microcontroller, and/or other processing devices. Controller 310 is configured to receive inputs from temperature sensor 314 and to control heater 308 in real-time, thereby maintaining the solution 306 at a desired thermal profile. In some embodiments, controller 310 may include and/or execute a parameter model (e.g., as described above) configured to determine or suggest appropriate solvolysis conditions (e.g., temperature, time, agitation speed) based on an identifier or physical properties of the CFRP feedstock, such as source, fiber type, weave architecture, resin system, and/or other characteristics.

To enhance the degradation of the CFRP feedstock 304 and facilitate carbon fiber separation, system 300 may include a stirrer 312 disposed at least partially within reactor vessel 302. Stirrer 312 is configured to mechanically agitate the CFRP feedstock 304 and solvolysis solution 306 in reactor vessel 302 during the heating to facilitate CFRP feedstock 304 degradation and carbon fiber dispersion. Stirrer 312 is configured to cause the carbon fibers to gradually disperse and reduce or eliminate entanglement of carbon fibers on stirrer 312. In some embodiments, stirrer 312 is a hook-type stirrer, comprising a curved or looped geometry configured to reduce fiber entanglement. This may be important, for example, when processing woven or long-fiber composite laminates. Stirrer 312 may be driven by an electric motor (and/or other similar components) coupled via a shaft or belt drive, for example. In some embodiments, stirrer 312 may provide a thermal conduit if integrated with a heating element, for example.

Following solvolysis, the degraded resin and carbon fibers are separated. A press 316, such as a hydraulic press, may be used to remove excess liquid from the fiber mass prior to washing. Press 316 may be housed within a same reactor module or as part of a downstream processing station. The pressed fibers are transferred to a washer 318, where they undergo rinsing in a continuously agitated aqueous solution to remove residual resin and solvent. Agitation may be achieved using rotating paddles, drum rotation, recirculated fluid jets, and/or other techniques. In some embodiments, system 300 may adapt industrial textile washing machines, leveraging existing wool-processing technologies for efficient, uniform cleaning at scale, for example.

After rinsing, the fibers are conveyed to a dryer 320 for moisture removal. In some embodiments, drying is conducted using a wool drying technique, involving low-velocity heated air and/or centrifugal spin cycles that gently remove moisture while preserving fiber length and surface quality. In some embodiments, heated air may be passed over the rinsed fibers at a controlled flow rate, with drying temperatures typically above about 40 °C, depending on fiber mass and desired dryness and/or other factors.

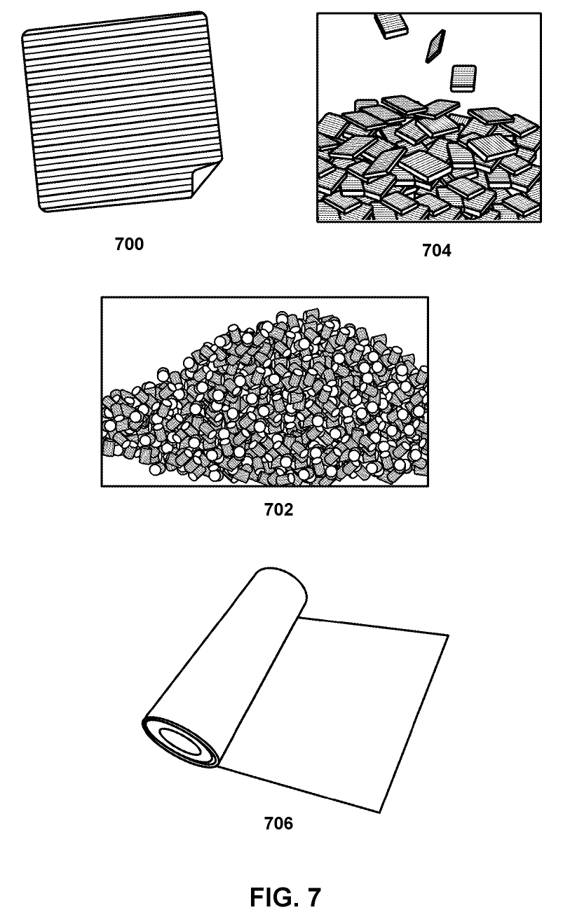

In some embodiments, the dried carbon fibers may be processed into various product forms including chopped carbon fibers, pellets, non-woven or woven fabrics, unidirectional carbon fiber rolls, or pre-impregnated (prepreg) components (see FIG. 7). These downstream manufacturing steps may occur on-site or in an integrated production line coupled to system 300, enabling seamless transition from recycled feedstock to high-performance composite inputs. This end-to-end capability enhances circularity, cost-effectiveness, and quality assurance in recycled carbon fiber production, for example, and/or provides other advantages.

In some embodiments, controller 310 is configured (e.g., as shown by the dashed lines in FIG. 3) to communicate with and control stirrer 312, press 316, washer 318, dryer 320, and/or other components, via wired interfaces such as serial (RS-485), USB, or Ethernet connections, or via wireless protocols including Wi-Fi, Bluetooth, or Zigbee, depending on system architecture and spatial configuration and/or other factors. Controller 310 may regulate stirrer 312 by adjusting parameters such as rotational speed (RPM), agitation mode (e.g., continuous versus pulsed), direction of rotation, etc., which may be constant or varied during solvolysis to optimize fiber dispersion and minimize entanglement. For press 316, controller 310 may control pressing force, dwell time, compression cycles and/or other factors based on batch size, fiber saturation, moisture content, etc., using pressure sensors, displacement transducers, and/or other sensors included in press 316 to monitor and automate the pressing operation. For washer 318, controller 310 may control the duration of washing, temperature of the wash water, flow rate or agitation speed, etc., to ensure consistent removal of resin and solvent residues. Similarly, for dryer 320, controller 310 may control air temperature, flow rate, drying duration, humidity levels, etc., using inputs from temperature and humidity sensors (and/or other sensors) within the drying chamber. Controller 310 may execute pre-programmed cleaning and drying cycles, or dynamically adjust parameters based on real-time sensor feedback, material identification data, operator input via a user interface (see FIG. 8), etc..

Controller 310 is configured to coordinate the operation of the other components of system 300 to provide the functionality described herein. However, in some embodiments, some system 300 components may also be configured to communicate directly with one another. For example, temperature sensor 314 may transmit real-time temperature data directly to heater 308 or stirrer 312 to enable localized feedback control independent of controller 310. Similarly, washer 318 and dryer 320 may exchange operational status signals to coordinate cycle timing and ensure that drying only begins once washing is complete, thereby improving system efficiency and automation.

Controller 310 and/or other components of system 300 may electronically access external resources to facilitate the functionality described herein. External resources, in some embodiments, include sources of information such as databases, websites, etc.; external entities participating with system 300, one or more servers outside of system 300, a network (e.g., the internet), electronic storage, equipment related to Wi-Fi ™ technology, equipment related to Bluetooth® technology, data entry devices, or other resources. In some implementations, some or all of the functionality attributed herein to the external resources may be provided by resources included in system 300. Communication with external resources may be via wired and/or wireless connections, via a network (e.g., a local area network and/or the internet), via cellular technology, via Wi-Fi technology, and/or via other resources.

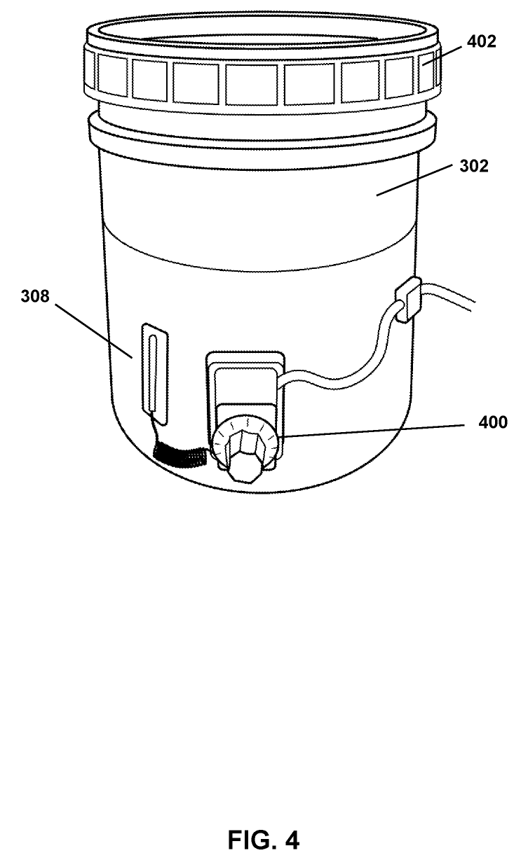

FIG. 4 illustrates an example of a reactor vessel 302, with a heater 308. In this example, reactor vessel 302 comprises an HDPE container, and heater 308 comprises a heating jacket. The heating jacket is controlled by a manually operated temperature dial 400. In this embodiment, reactor vessel 302, which comprises a high-density polyethylene (HDPE) container, offers a combination of chemical resistance, low cost, and sufficient thermal durability for mild solvolysis operations conducted at atmospheric pressure and moderate temperatures (e.g., up to approximately 100 °C). The vessel includes a removable lid 402, enabling easy access for the introduction of CFRP feedstock and solvolysis solution, as well as for cleaning and maintenance. HDPE also provides sufficient mechanical stability for batch-scale processing while being light enough for modular use, such as in small-scale or distributed recycling facilities.

Heater 308 in this embodiment comprises a flexible silicone heating jacket that wraps around a substantial portion of the reactor vessel’s circumference. The heating jacket includes an integrated temperature control dial 400, which is manually adjustable to set and regulate the desired temperature of the reactor contents. The control dial 400 is electrically connected to the heating element embedded within the jacket, allowing heat to be applied uniformly to the vessel wall, thereby increasing the temperature of the solvolysis solution and the CFRP feedstock inside. In some embodiments, the heating jacket may be rated for continuous operation within a specific thermal range (e.g., 40 °C to 100 °C) and includes built-in thermal protection to prevent overheating. For example, the silicon heating jacket may be configured to raise 10L of solvent to a temperature of 50C from 24C in approximately 45 minutes using less than 0.2kWh. In this example, a Bluetooth thermometer may be configured to measure the temperature in the center of reactor vessel 302.

Although some embodiments are configured for manual temperature control, other embodiments may incorporate digital thermostats, PID controllers, or integration with an external controller 310 (FIG. 3) for automated, sensor-driven thermal regulation based on real-time temperature feedback from a sensor such as temperature sensor 314. This configuration offers a cost-effective, replicable solution for laboratory or pilot-scale operations and provides the modularity described herein. The use of components such as HDPE container and silicone heating wrap significantly reduces capital expenditure requirements compared to prior solvolysis systems, and accelerates deployment timelines, thus making CFRP recycling more accessible and scalable.

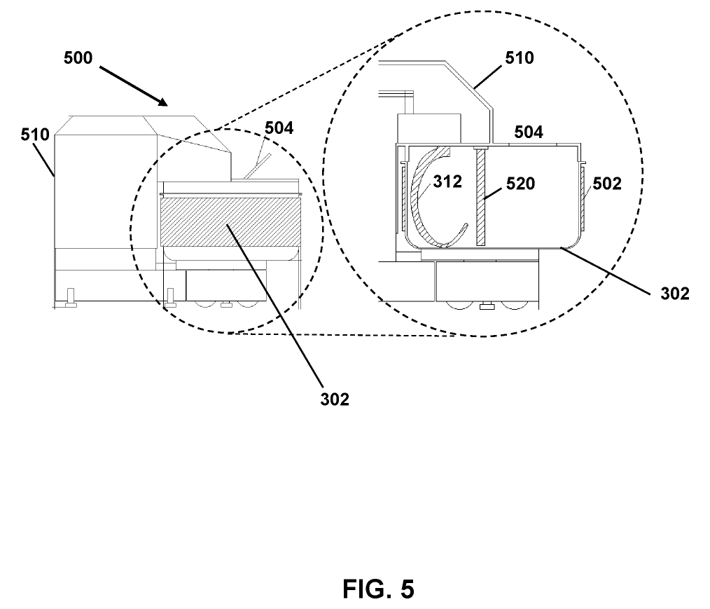

FIG. 5 illustrates an additional potential embodiment 500 of reactor vessel 302. Embodiment 500 is on more of an industrial scale, with a larger reactor tank size construction and/or other features conducive for industrial use. FIG. 5 illustrates a heating jacket and insulation 502, a hatch 504 for accessing reactor vessel 302, hook-type stirrer 312, an industrial outer housing 510, and/or other components. FIG. 5 illustrates an example embodiment of an industrial reactor system for recycling carbon fiber reinforced plastics (CFRP), showing how a modular reactor vessel 302 may be integrated into a larger, scalable processing unit. Embodiment 500 is configured for higher-throughput operation and includes a protective enclosure or housing 510, which surrounds a support frame and various control, mechanical, and electrical subsystems. Reactor vessel 302 may be positioned within a frame, and is partially shown in cross-section to reveal internal features such as stirrer 312, which is configured to agitate the solvolysis solution and CFRP feedstock during operation. Stirrer 312 may be a hook-type stirrer, as described above, and may be driven by a motor mounted above, below, or adjacent to the vessel. The motor may be configured to provide variable speed and direction control, for example. Hatch 504 (e.g., an access port or lid) may be used for loading CFRP material or solvent, sampling contents, or cleaning the interior of the vessel, for example.

In some embodiments, embodiment 500 includes various components that enable automated, sensor-controlled operation, suitable for industrial-scale CFRP recycling. A motorized drive unit may be integrated to rotate stirrer 312 via a shaft and gearbox arrangement, with motor speed and torque controlled by, for example, an inverter or variable frequency drive (VFD). The system may further include a user interface (UI) or touchscreen panel for manual control and/or parameter setting, enabling the user to input values such as reaction temperature, mixing speed, dwell time, and agitation profiles. A controller (e.g., PLC or microcontroller, and/or controller 310 described above) may be integrated within housing 510 to manage feedback loops using input from sensors - such as temperature sensors, load cells, and liquid level sensors - that monitor process parameters in real time. Housing 510 may also contain safety interlocks, thermal cutoffs, and solvent vapor containment features. Materials used to construct such a reactor system may include stainless steel (e.g., 304 or 316) for chemical compatibility and durability, HDPE or PTFE-lined components for corrosion resistance, and polycarbonate or aluminum for housings or structural enclosures. The modular design enables easy substitution or expansion of reactor vessels 302 in multi-reactor arrays, allowing for continuous operation even while individual units are serviced or reloaded, for example.

In this example, fibers are mechanically dispersed during degradation. The solvolysis solution / fiber mixture may be sealed within a stainless steel bowl reactor vessel 302 with an HDPE hatch 504, and other wetted components formed using HDPE, which is suitable for a corrosive solvent. The example footprint of embodiment 500 may be able to support a 250L batch (for illustration). Hatch 504 facilitates dosing additional solvent as necessary during solvolysis. In some embodiments, the bowl reactor vessel 302 may be disposed on or otherwise coupled to a rotating unit. In some embodiments, a split column 520 may be used to create additional turbulence and dispersion effects. Heating jacket and insulation 502 may be configured to heat the solvolysis solution from the outside of (e.g., stainless steel) bowl reactor vessel 302. However, in some embodiments, the mixing hook or split column may be configured to be used as an induction heater.

FIG. 6 illustrates example embodiments of post-solvolysis processing equipment for handling recovered carbon fibers. Specifically, press 316 is shown as embodiment 600, washer 318 as embodiment 602, and dryer 320 as embodiment 604. FIG. 6 also illustrates a filter/ silo 606 that could be used to separate the bulk of the epoxy from the used chemicals. These components form part of an integrated downstream treatment system configured to process carbon fibers following separation from the solvolysis solution. After solvolysis, the chemical solution is removed - e.g., via gravity drainage or pump-assisted evacuation - for distillation, solvent reuse, and/or other purposes. This may be performed using filter / silo 606 and/or other equipment. In this example (many other embodiments are possible), filter / silo 606 holds a mixture 608 in a separating funnel 610. Filtered liquid 612 is removed (by gravity and controlled by a stopper 616 in this example) and collected in a container 618.

The remaining fiber mass retains excess liquid (e.g., solvent and partially degraded resin) and is often swollen and difficult to handle manually. Press 316 (embodiment 600) may be configured as a hydraulic or pneumatic press, for example, capable of exerting sufficient force to compact the fiber mass and expel residual liquid prior to washing. In some embodiments, press 316 may include a perforated inner chamber or drainage ports to collect the expelled liquid for reuse or safe disposal, for example.

For industrial deployment, press 316 may be constructed from stainless steel, aluminum alloys, or coated steel to resist corrosion from residual chemicals. The system may include an electric or hydraulic motor, and be controlled via a controller (e.g., controller 310 shown in FIG. 3) such as a programmable logic controller (PLC) and/or dedicated user interface (UI), allowing operators to set pressing force, dwell time, temperature, pressing cycle characteristics, etc.. Safety features may include pressure sensors, interlocks, and emergency shutoff switches. After pressing, fibers may be transferred to washer 318 (embodiment 602), which is shown as a horizontal industrial drum washer, adapted from textile or wool-processing industries. Washer 318 may feature continuous agitation, a rotating drum with perforations, and integrated chemical dosing systems for adding neutralizing or cleaning agents. Washing removes residual resin, epoxy fragments, and chemical traces, helping to provide fibers that are ready for downstream processing.

Dryer 320 (embodiment 604) is shown as a centrifugal industrial dryer, which operates by spinning the fiber mass at high speeds while applying controlled thermal airflow. Drying parameters - such as air temperature, spin speed, and cycle time - may be selected via a digital control panel and monitored using embedded temperature and humidity sensors, determined and/or otherwise controlled by a controller (e.g., controller 310 shown in FIG. 3), and/or may be determined using other operations. Dryer 320 may also include programmable presets for different fiber types or batch sizes. Materials for construction may include 304 or 316 stainless steel for wetted parts, (e.g., polycarbonate) covers for safety, components such as high-durability elastomers for vibration isolation, and/or other components. In some embodiments, dryer 320 may incorporate multi-stage drying cycles, beginning with centrifugal dewatering and ending with gentle heated air to prevent thermal degradation of the carbon fibers, for example. These systems, when used in combination, ensure high-throughput, consistent-quality fiber recovery while minimizing labor and energy use – which are important considerations for commercial and industrial-scale CFRP recycling operations.

FIG. 7 illustrates various products, such as a non-woven fabric 700, carbon fiber pellets 702, chopped carbon fiber 704, and unidirectional carbon fiber 706 (there are other examples), that can be produced with the recycled carbon fibers after solvolysis, washing, and/or drying. Non-woven fabric 700 represents an advanced form of non-woven carbon fiber material formed from recycled fibers. This material is typically produced by carding, laying, and thermally or chemically bonding dispersed carbon fibers recovered through solvolysis and processed through rinsing and drying stages. Non-woven fabric can feature fine fiber orientation and porosity while maintaining a lightweight, durable structure suitable for aerospace panels, automotive interior components, filtration systems, and protective equipment. The use of micro-length fibers enables a smooth surface finish and structural adaptability, making the fabric highly compatible with vacuum infusion, compression molding, or resin transfer molding (RTM) techniques, for example. Because the recycled fibers may retain up to 90% of the tensile strength of virgin carbon fiber, the resulting fabric can be used in high-performance composite applications while dramatically lowering material costs and environmental impact, among other advantages.

Carbon fiber pellets 702 may be manufactured by combining short, high-strength chopped carbon fibers with thermoplastic resins such as polypropylene (PP), polyamide (PA), polyether ether ketone (PEEK), or ABS. These pellets may be optimized for injection molding and other thermoplastic processing methods, offering enhanced mechanical strength, dimensional stability, and impact resistance, for example. The pellets can be formulated in various sizes (e.g., 1 mm–5 mm diameter) and carbon fiber loadings (e.g., 10–50%) to suit specific application needs, such as automotive lightweighting, electronics casings, and sporting goods, among others. The manufacturing process may involve extrusion, cooling, and granulation, and leverages the compatibility between the surface-treated recycled carbon fibers and the matrix polymer.

Chopped carbon fiber 704 refers to individual fiber segments typically cut to lengths of 6 mm to 10 mm, for example, depending on the application. These are produced from the rinsed and dried carbon fiber output of the solvolysis process using mechanical cutting tools or rotary choppers and/or other equipment. Chopped fiber is versatile and widely used in thermoplastic and thermoset compounding, e.g., for reinforced molded parts, construction materials (e.g., fiber-reinforced concrete), and textiles. The chopped form retains much of the mechanical strength of continuous fiber while offering ease of dispersion in polymer matrices or cementitious materials. Additionally, the use of chopped fibers in composite layups or pellet blends enables tailored reinforcement characteristics while simplifying handling and processing logistics in both batch and continuous production environments.

Unidirectional carbon fiber 706 may be produced by realigning and laying recycled long fibers in a parallel, collimated configuration, often stabilized with a binder or pre-impregnated with resin (creating a prepreg). This material is engineered for high-strength structural reinforcement, particularly in applications requiring directional load-bearing capability, such as aerospace skin reinforcements, turbine blades, bicycle frames, and automotive chassis components. Recycled unidirectional tapes or sheets are typically created using modified spreading, aligning, and calendering techniques, sometimes integrated with heat-activated adhesive films to maintain alignment before molding. Because fiber continuity and alignment are important, this form benefits from advanced recovery processes that minimize fiber damage and retain extended strand length. Recycled unidirectional carbon fiber enables circularity in high-performance applications traditionally dominated by virgin fiber products.

FIG. 8 is a diagram that illustrates an exemplary computer system 800 in accordance with embodiments of the present system. Various portions of systems and methods described herein may include or be executed on one or more computer systems the same as or similar to computer system 800. For example, controller 310 and/or other components of system 300 (FIG. 3) may be and/or include one more computer systems the same as or similar to computer system 800. Further, processes performed by system 300 described herein may be executed by one or more processing systems similar to and/or the same as that of computer system 800.

Computer system 800 may include one or more processors (e.g., processors 810a-810n) coupled to system memory 820, an input/output I/O device interface 830, and a network interface 840 via an input/output (I/O) interface 850. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computer system 800. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 820). Computer system 800 may be a uni-processor system including one processor (e.g., processor 810a), or a multi-processor system including any number of suitable processors (e.g., 810a-810n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computer system 800 may include a plurality of computing devices (e.g., distributed computer systems) to implement various processing functions.

I/O device interface 830 may provide an interface for connection of one or more I/O devices 860 to computer system 800. I/O devices may include devices that receive input (e.g., from a user) or output information (e.g., to a user). I/O devices 860 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 860 may be connected to computer system 800 through a wired or wireless connection. I/O devices 860 may be connected to computer system 800 from a remote location. I/O devices 860 located on a remote computer system, for example, may be connected to computer system 800 via a network N and network interface 840.

Network interface 840 may include a network adapter that provides for connection of computer system 800 to network N. Network interface may 840 may facilitate data exchange between computer system 800 and other devices connected to the network. Network interface 840 may support wired or wireless communication. The network may include an electronic communication network, such as the Internet, a local area network (LAN), a wide area network (WAN), a cellular communications network, or the like.

System memory 820 may be configured to store program instructions 870 or data 880. Program instructions 870 may be executable by a processor (e.g., one or more of processors 810a-810n) to implement one or more embodiments of the present techniques. Instructions 870 may include modules and/or components (e.g., components 16, 18, and/or 20 shown in FIG. 1) of computer program instructions for implementing one or more techniques described herein with regard to various processing modules and/or components. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 820 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 820 may include a non-transitory computer readable storage medium that may have program instructions stored thereon that are executable by a computer processor (e.g., one or more of processors 810a-810n) to cause the subject matter and the functional operations described herein. A memory (e.g., system memory 820) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 850 may be configured to coordinate I/O traffic between processors 810a-810n, system memory 820, network interface 840, I/O devices 860, and/or other peripheral devices. I/O interface 850 may perform protocol, timing, or other data transformations to convert data signals from one component (e.g., system memory 820) into a format suitable for use by another component (e.g., processors 810a-810n). I/O interface 850 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 800 or multiple computer systems 800 configured to host different portions or instances of embodiments. Multiple computer systems 800 may provide for parallel or sequential processing/execution of one or more portions of the techniques described herein.

Those skilled in the art will appreciate that computer system 800 is merely illustrative and is not intended to limit the scope of the techniques described herein. Computer system 800 may include any combination of devices or software that may perform or otherwise provide for the performance of the techniques described herein. For example, computer system 800 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a television or device connected to a television (e.g., Apple TV ™), or a Global Positioning System (GPS), or the like. Computer system 800 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 800 may be transmitted to computer system 800 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to cost constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X’ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present techniques will be better understood with reference to the following enumerated embodiments:
1. A method for recycling carbon fiber reinforced plastics (CFRP), comprising: introducing CFRP feedstock together with a solvolysis solution into a reactor vessel for solvolysis, the reactor vessel configured to maintain the CFRP feedstock and the solvolysis solution at atmospheric pressure; heating the reactor vessel to increase a temperature of the solvolysis solution and the CFRP feedstock to maintain a target temperature for a period of time; mechanically agitating the CFRP feedstock and the solvolysis solution in the reactor vessel with a stirrer during the heating to facilitate CFRP feedstock degradation and carbon fiber dispersion, the stirrer configured to cause the carbon fibers to gradually disperse and reduce or eliminate entanglement of carbon fibers on the stirrer; separating recovered carbon fibers from the solvolysis solution; rinsing the recovered carbon fibers with a washing process to remove residual resin and chemical residues; and drying the rinsed carbon fibers.
2. The method of embodiment 1, wherein the solvolysis solution comprises a target mixture of radicals configured to break chemical bonds in the CFRP feedstock.
3. The method of any of the previous embodiments, wherein the heating is performed by a heater comprising a heating jacket configured to wrap around at least a portion of the reactor vessel.
4. The method of any of the previous embodiments, wherein the reactor vessel is modular, with reactor vessel modularity configured to facilitate reactor vessel replacement, and/or scaling by adding or subtracting a number of reactor vessels used for the method while solvolysis is ongoing in other reactor vessels.
5. The method of any of the previous embodiments, wherein an electronic parameter model is configured to determine one or more of temperature, time, and/or agitation parameters of the solvolysis based on a CFRP feedstock identifier, and/or physical characteristics of the CFRP feedstock.
6. The method of any of the previous embodiments, further comprising forming chopped carbon fibers, pellets, fabrics, a unidirectional carbon fiber roll, and/or pre-impregnated carbon fiber components from the dried rinsed carbon fibers.
7. The method of any of the previous embodiments, wherein the CFRP feedstock is obtained from retired aircraft.
8. The method of any of the previous embodiments, wherein the stirrer is a hook-type stirrer.
9. The method of any of the previous embodiments, wherein the reactor vessel comprises high-density polyethylene (HDPE).
10. The method of any of the previous embodiments, wherein the reactor vessel comprises stainless steel.
11. The method of any of the previous embodiments, further comprising distilling and reusing the solvolysis solution after separation of the carbon fibers.
12. The method of any of the previous embodiments, further comprising pressing the recovered carbon fibers using a hydraulic press before rinsing.
13. The method of any of the previous embodiments, wherein the washing process comprises immersion of the recovered carbon fibers in a continuously agitated aqueous solution.
14. The method of any of the previous embodiments, wherein drying the rinsed carbon fibers is performed using a wool drying technique.
15. The method of any of the previous embodiments, wherein the drying the rinsed carbon fibers comprises passing heated air over the rinsed carbon fibers at a controlled flow rate.
16. A reactor system for recycling carbon fiber reinforced plastics (CFRP), comprising: a reactor vessel configured to receive CFRP feedstock together with a solvolysis solution for solvolysis, the reactor vessel configured to maintain the CFRP feedstock and the solvolysis solution at atmospheric pressure; a heater configured to heat the reactor vessel to increase a temperature of the solvolysis solution and the CFRP feedstock and maintain a target temperature for a period of time; and a stirrer configured to mechanically agitate the CFRP feedstock and the solvolysis solution in the reactor vessel during the heating to facilitate CFRP feedstock degradation and carbon fiber dispersion, the stirrer configured to cause the carbon fibers to gradually disperse and reduce or eliminate entanglement of carbon fibers on the stirrer.
17. The system of embodiment 16, wherein the reactor vessel is modular, with reactor vessel modularity configured to facilitate reactor vessel replacement, and/or scaling by adding or subtracting a number of reactor vessels used for solvolysis, while solvolysis is ongoing in other reactor vessels.
18. The system of any of the previous embodiments, wherein the reactor vessel is formed using high-density polyethylene (HDPE).
19. The system of any of the previous embodiments, wherein the reactor vessel is formed using stainless steel.
20. The system of any of the previous embodiments, wherein the heater comprises a heating jacket configured to wrap around at least a portion of the reactor vessel.
21. The system of any of the previous embodiments, wherein the stirrer is a hook-type stirrer.
22. The system of any of the previous embodiments, further comprising: a temperature sensor configured to generate one or more output signals that indicate the temperature of the solvolysis solution; and a controller configured to control the heater in real time to heat the reactor vessel as needed based on the temperature of the solvolysis solution.
23. The system of any of the previous embodiments, wherein the CFRP feedstock is obtained from retired aircraft.
24. The system of any of the previous embodiments, wherein the solvolysis solution is relatively mild compared to typical solvolysis solutions used for CFRP recycling.
25. A recycled carbon fiber product produced using the method of and/or the system of any of the previous embodiments, the recycled carbon fiber product comprising chopped carbon fibers, pellets, fabrics, a unidirectional carbon fiber roll, and/or pre-impregnated carbon fiber components.

What is claimed is:

1. A method for recycling carbon fiber reinforced plastics (CFRP), comprising:
introducing CFRP feedstock together with a solvolysis solution into a reactor vessel for solvolysis, the reactor vessel configured to maintain the CFRP feedstock and the solvolysis solution at atmospheric pressure;
heating the reactor vessel to increase a temperature of the solvolysis solution and the CFRP feedstock to maintain a target temperature for a period of time;
mechanically agitating the CFRP feedstock and the solvolysis solution in the reactor vessel with a stirrer during the heating to facilitate CFRP feedstock degradation and carbon fiber dispersion, the stirrer configured to cause the carbon fibers to gradually disperse and reduce or eliminate entanglement of carbon fibers on the stirrer;
separating recovered carbon fibers from the solvolysis solution;
rinsing the recovered carbon fibers with a washing process to remove residual resin and chemical residues; and
drying the rinsed carbon fibers.

2. The method of claim 1, wherein the solvolysis solution comprises a target mixture of radicals configured to break chemical bonds in the CFRP feedstock.

3. The method of claim 1, wherein the heating is performed by a heater comprising a heating jacket configured to wrap around at least a portion of the reactor vessel.

4. The method of claim 1, wherein the reactor vessel is modular, with reactor vessel modularity configured to facilitate reactor vessel replacement, and/or scaling by adding or subtracting a number of reactor vessels used for the method while solvolysis is ongoing in other reactor vessels.

5. The method of claim 1, wherein an electronic parameter model is configured to determine one or more of temperature, time, and/or agitation parameters of the solvolysis based on a CFRP feedstock identifier, and/or physical characteristics of the CFRP feedstock.

6. The method of claim 1, further comprising forming chopped carbon fibers, pellets, fabrics, a unidirectional carbon fiber roll, and/or pre-impregnated carbon fiber components from the dried rinsed carbon fibers.

7. The method of claim 1, wherein the CFRP feedstock is obtained from retired aircraft.

8. The method of claim 1, wherein the stirrer is a hook-type stirrer.

9. The method of claim 1, wherein the reactor vessel comprises high-density polyethylene (HDPE).

10. The method of claim 1, wherein the reactor vessel comprises stainless steel.

11. The method of claim 1, further comprising distilling and reusing the solvolysis solution after separation of the carbon fibers.

12. The method of claim 1, further comprising pressing the recovered carbon fibers using a hydraulic press before rinsing.

13. The method of claim 1, wherein the washing process comprises immersion of the recovered carbon fibers in a continuously agitated aqueous solution.

14. The method of claim 1, wherein drying the rinsed carbon fibers is performed using a wool drying technique.

15. The method of claim 1, wherein the drying the rinsed carbon fibers comprises passing heated air over the rinsed carbon fibers at a controlled flow rate.

16. A reactor system for recycling carbon fiber reinforced plastics (CFRP), comprising:
a reactor vessel configured to receive CFRP feedstock together with a solvolysis solution for solvolysis, the reactor vessel configured to maintain the CFRP feedstock and the solvolysis solution at atmospheric pressure;
a heater configured to heat the reactor vessel to increase a temperature of the solvolysis solution and the CFRP feedstock and maintain a target temperature for a period of time; and
a stirrer configured to mechanically agitate the CFRP feedstock and the solvolysis solution in the reactor vessel during the heating to facilitate CFRP feedstock degradation and carbon fiber dispersion, the stirrer configured to cause the carbon fibers to gradually disperse and reduce or eliminate entanglement of carbon fibers on the stirrer.

17. The system of claim 16, wherein the reactor vessel is modular, with reactor vessel modularity configured to facilitate reactor vessel replacement, and/or scaling by adding or subtracting a number of reactor vessels used for solvolysis, while solvolysis is ongoing in other reactor vessels.

18. The system of claim 16, wherein the reactor vessel is formed using high-density polyethylene (HDPE).

19. The system of claim 16, wherein the reactor vessel is formed using stainless steel.

20. The system of claim 16, wherein the heater comprises a heating jacket configured to wrap around at least a portion of the reactor vessel.

21. The system of claim 16, wherein the stirrer is a hook-type stirrer.

22. The system of claim 16, further comprising:
a temperature sensor configured to generate one or more output signals that indicate the temperature of the solvolysis solution; and
a controller configured to control the heater in real time to heat the reactor vessel as needed based on the temperature of the solvolysis solution.

23. The system of claim 16, wherein the CFRP feedstock is obtained from retired aircraft.

24. The system of claim 16, wherein the solvolysis solution is relatively mild compared to typical solvolysis solutions used for CFRP recycling.
